(19) United States
(12) Patent Application Publication
(10) Pub. No.: US 2014/0244801 A1
(43) Pub. Date: Aug. 28, 2014

(54) NETWORK-BASED DISTRIBUTION SYSTEM SUPPORTING TRANSFER OF APPLICATION PRODUCTS

(71) Applicant: APPLE INC., Cupertino, CA (US)

(72) Inventors: Aloke Bhatnagar, Campbell, CA (US); Ricardo D. Cortes, Los Gatos, CA (US); Max Muller, San Jose, CA (US); David Alonzo Van Tassell, Campbell, CA (US); Amit Shirsat, Sunnyvale, CA (US); Ashish Agarwal, San Jose, CA (US); Marianne Edgeworth, San Jose, CA (US)

(73) Assignee: APPLE INC., Cupertino, CA (US)

(21) Appl. No.: 13/781,533

(22) Filed: Feb. 28, 2013

(51) Int. Cl. H04L 29/08

(52) U.S. Cl. CPC H04L 67/02
USPC 709/219

(57) ABSTRACT

An improved system, device and method for transferring a digital asset (e.g., digital product) from a requestor to a recipient with assistance from an asset distribution system. According to one aspect, a requester who has one or more digital assets available for distribution by an online asset distribution system can invoke a transfer of at least one of such digital assets to a recipient. The online asset distribution system can manage the transfer of a digital asset from the requestor to the recipient. The management of the transfer includes one or more of ensuring eligibility of the recipient and/or the digital asset for the transfer, ensuring acceptance of the transfer by the recipient, ensuring acceptance of contract terms governing the transfer, performing the transfer of the digital asset to the recipient, and/or providing various electronic status notifications to the requestor and/or the recipient.

### BACKGROUND OF THE INVENTION

Today, online digital stores, such as iTunes™ Store, allow customers (i.e., online users) to purchase or rent digital items, such as music, videos or computer programs, over the Internet. Often, at online stores, numerous digital items are made available and are provided by various different content providers, such as music labels, movie companies or software developers. Software tools, such as iTunes Producer™ and iTunes Label Connect™ available from Apple Inc. of Cupertino, Calif., can assist content providers with online submission of digital content to online digital stores.

Since digital stores that distribute digital assets support large numbers of content providers, it is not uncommon for one content provider to be sold, acquired, merged or otherwise absorbed by another content provider. In such cases, content providers normally want to manage their digital content from a common account with the digital store. Hence, digital content previously made available at the digital store by the initial content provider needs to be removed from the digital store, and then the new content provider can resubmit the digital content to the store. Hence, manual performance of resubmission of digital assets to a digital store can be an onerous task, particular when there is a large number of digital items. Hence, there is a need for improved approaches to facilitate ownership changes with respect to content providers for digital assets.

### SUMMARY

The invention relates to a system, device and method for transferring a digital asset (e.g., digital product) from a requestor to a recipient with assistance from an asset distribution system.

According to one aspect, a requester who has one or more digital assets available for distribution by an online asset distribution system can invoke a transfer of at least one of such digital assets to a recipient. The online asset distribution system can manage the transfer of a digital asset from the requestor to the recipient. The management of the transfer includes one or more of ensuring eligibility of the recipient and/or the digital asset for the transfer, ensuring acceptance of the transfer by the recipient, ensuring acceptance of contract terms governing the transfer, performing the transfer of the digital asset to the recipient, and/or providing various electronic status notifications to the requestor and/or the recipient.

The invention can be implemented in numerous ways, including as a method, system, device, apparatus (including computer readable medium and graphical user interface). Several embodiments of the invention are discussed below.

As a computer-implemented method for transferring a digital asset from one user account of an online asset distribution system to another user account, one embodiment can, for example, include at least: receiving a transfer request from a requestor, the transfer request being associated with at least one particular digital asset currently associated with the requestor at the online asset distribution system; determining whether the at least one particular digital asset is eligible for transfer; and informing the requestor that the at least one particular digital asset is not eligible for transfer, if it is determined that the at least one particular digital asset is not eligible for transfer. Thereafter, the embodiment can, for example, further include at least: receiving information pertaining to a recipient that is to receive the at least one particular digital asset if it is determined that the at least one particular digital asset is eligible for transfer; validating, after receiving the information pertaining to the recipient, that the recipient is a permitted recipient of the at least one particular digital asset; subsequently receiving a transfer contract acceptance from the recipient indicating acceptance of a transfer contract governing the transfer of the digital asset from the requestor to the recipient; and initiating, after receiving the transfer contract acceptance, transfer of the digital asset from the requestor to the recipient.

As a non-transitory computer readable medium including at least computer program code tangibly stored thereon for transferring a digital asset from a requestor to a recipient, the digital asset being available for distribution from an online asset distribution system, one embodiment can, for example, include at least: computer program code for receiving a transfer request from the requestor, the transfer request being associated with the transfer of at least one particular digital asset currently associated with the requestor to the recipient; computer program code for determining whether the at least one particular digital asset is eligible for transfer; computer program code for receiving information pertaining to a recipient that is to receive the at least one particular digital asset if it is determined that the at least one particular digital asset is eligible for transfer; and computer program code for electronically notifying the recipient that a transfer request to them has been made.

As a computing system for supporting an online asset distribution system, one embodiment can, for example, include at least: at least one memory configured to store user account information and computer program code; and a least one computing device for executing at least a portion of the computer program code for transferring a digital asset from a requesting user to a recipient user, where both the requesting user and the recipient user have accounts with the online asset distribution system. Additionally, the computer readable medium can, for example, includes at least: computer program code for receiving a transfer request from the requestor, the transfer request being associated with the transfer of at least one particular digital asset currently associated with the requestor to the recipient; computer program code for determining whether the at least one particular digital asset is eligible for transfer; computer program code for receiving information pertaining to a recipient that is to receive the at least one particular digital asset if it is determined that the at least one particular digital asset is eligible for transfer; and computer program code for electronically notifying the recipient that a transfer request to them has been made.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a product submission and distribution system 100 according to one embodiment.

FIG. 2 illustrates a basic state diagram for a transfer process according to one embodiment.

FIG. 3 illustrates a flow diagram of a transfer request process according to one embodiment.

FIG. 4 illustrates a flow diagram of a transfer acceptance process according to one embodiment.

FIGS. 5A and 5B illustrate flow diagrams of a transfer request process according to one embodiment.

FIGS. 6A and 6B illustrate flow diagrams of a transfer acceptance process according to one embodiment.

FIG. 6C illustrates a flow diagram of processing associated with export processing of the digital asset to a recipient.

### DETAILED DESCRIPTION OF CERTAIN EMBODIMENTS

The invention relates to a system, device and method for transferring a digital asset (e.g., digital product) from a requestor to a recipient with assistance from an asset distribution system.

According to one aspect, a requester who has one or more digital assets available for distribution by an online asset distribution system can invoke a transfer of at least one of such digital assets to a recipient. The online asset distribution system can manage the transfer of a digital asset from the requestor to the recipient. The management of the transfer includes one or more of ensuring eligibility of the recipient and/or the digital asset for the transfer, ensuring acceptance of the transfer by the recipient, ensuring acceptance of contract terms governing the transfer, performing the transfer of the digital asset to the recipient, and/or providing various electronic status notifications to the requestor and/or the recipient.

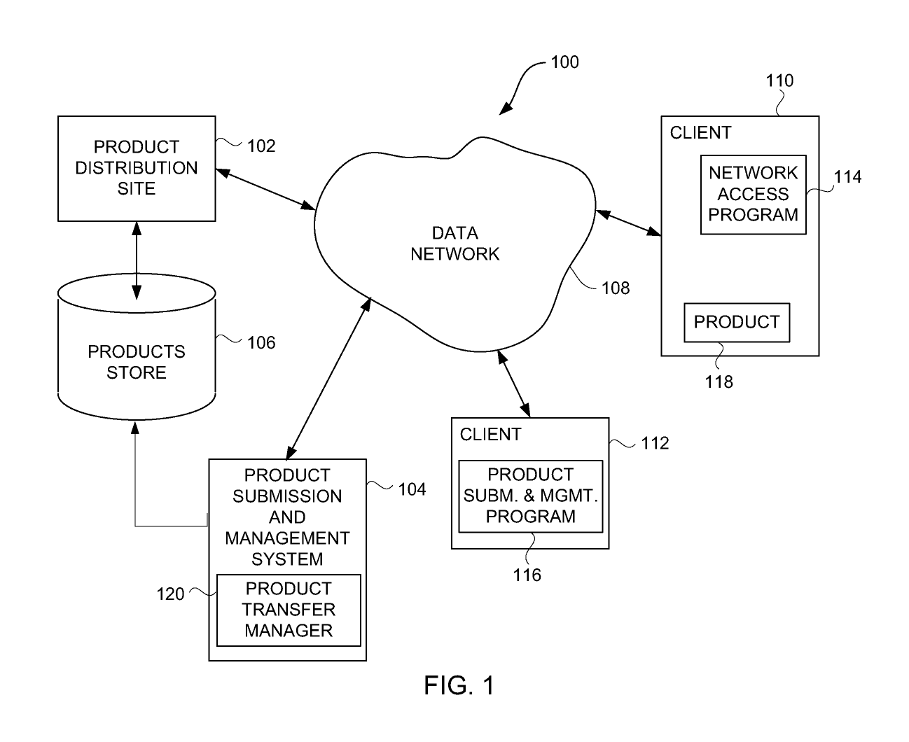

Embodiments of various aspects of the invention are discussed below with reference to FIGS. 1-6B. However, those skilled in the art will readily appreciate that the detailed description given herein with respect to these figures is for explanatory purposes as the invention extends beyond these limited embodiments.

FIG. 1 is a block diagram of a product submission and distribution system 100 according to one embodiment. The product submission and distribution system 100 serves as an asset distribution system. The product submission and distribution system 100 includes a product distribution site 102. The product distribution site 102 provides an online access point for distribution of various digital products. For example, the product distribution site 102 can support or be referred to as an online store or an online product distribution site. The product distribution site 102 can also be referred to as an online product hosting site. A product submission and management system 104 operates to receive submissions of digital products from various digital product submitters. The product submission and management system 104 can process submission of digital products and authorize distribution of approved digital products. The digital products can be stored in a products store 106. In one embodiment, the products store 106 includes a mass data store and/or one or more databases. The products store 106 typically provides mass storage of the numerous digital products that are available for distribution (e.g., purchase, lease or rental). For example, digital products that have been purchased can be accessed from the products store 106 over a data network 108 by way of the product distribution site 102. Examples of digital products are computer program products such as applications (or application programs or computer software programs), animations, or presentations. Other examples of digital products include videos, music or other media items.

The product submission and distribution system 100 also includes a first client 110 and a second client 112. Typically, the product submission and distribution system 100 would include a plurality of different clients 110, 112. The first client 110 includes a network access program 114. The second client 112 includes a product submission program 116. Some clients can also include both the network access program 114 and the product submission program 116. The network access program 114 is an application program (e.g., software application) that operates on the first client 110, which is a computing device. One example of a suitable network access program is a network browser (e.g., Microsoft Explorer or Safari). Another example of a suitable network access program is iTunes™ offered by Apple Inc. The first client 110 can be coupled to the product distribution site 102 through the data network 108. Hence, any of the first clients 110 can interact with the product distribution site 102 to review, purchase and/or manage digital products.

The product submission and management program 116 is also an application program (e.g., software application) that operates on the second client 112, which is a computing device. The product submission and management program 116 is used to submit digital products to the product submission and management system 104 for eventual distribution by the media distribution site 102. Although the network access program 114 and the product submission and management program 116 are shown in FIG. 1 as separate programs, it should be understood that such programs can be integrated into a single program or reside on the same client machine.

In the product submission and distribution system 100 shown in FIG. 1, the digital products are submitted to the product submission and management system 104 by way of the product submission and management program 116. The digital products that have been submitted (e.g., via the second client 112) are processed and then, if accepted, stored in the products store 106 for distribution. Thereafter, the stored digital products are available to be purchased from the product distribution site 102. The product submission and management program 116 can also be used to manage distribution of the submitted digital products. That is, a content provider that has submitted one or more digital products for distribution via the product distribution site 102 can manage those one or more digital products using the product submission and management program 116. Such management can include pricing, permitted geographic distribution, description, images, and various others.

The product submission and distribution system 100 allows a user of the client 110 to utilize the network access program 114 to browse, search or sort through a plurality of digital products that can be purchased from the product distribution site 102. The network access program 114 may also allow the user to preview or demo some or all of a digital product. In the event that the user of the network access program 114 desires to purchase a particular digital product, the user (via the network access program 114) and the product distribution site 102 can engage in an online commerce transaction in which the user pays for access rights to the particular digital product. In one embodiment, a credit card associated with the user (e.g., associated with user's account) is credited for a purchase or rental amount of the particular digital product.

Upon purchasing a particular digital product, the product distribution site 102 permits the digital data for the particular digital product to be retrieved from the products store 106 and then delivered (e.g., downloaded) from the product distribution site 102 to the requesting client 110 through the data network 108. In this regard, the product distribution site 102 or some other delivery server (not shown) obtains the digital data corresponding to the particular digital product from the products store 106 and downloads such digital data through the data network 108 to the client 110. The downloaded digital data can then be stored on the client 110. In one embodiment, the downloaded digital data is encrypted as received at the client 110 but is decrypted and then perhaps re-encrypted before being persistently stored on the client 110. Thereafter, the client 110 can utilize (e.g., execute) the digital data of the digital product at the client 110.

The submission and purchase of the digital products can be achieved over the data network 108. In other words, the submission and purchase of the digital products can be achieved online. The purchase of media items online can also be referred to as electronic commerce (e-commerce). In one embodiment, the data network 108 makes use of at least a portion of the Internet. In one embodiment, the connections through the data network 108 between the product distribution site 102 and the clients 110, 112 can be through secure connections, such as Secure Sockets Layer (SSL). The clients 110, 112 can vary with application but generally are computing devices that have memory storage. Often, the clients 110, 112 are personal computers or other computing devices that are capable of storing and presenting media to their users. In one embodiment, one or more of the clients can be portable computing devices (e.g., laptop or network computers) or handheld computing devices (e.g., PDAs, smart phones, multi-function electronic devices, or media players).

The product submission and distribution system 100 can also support transfer of one or more digital products between different content providers. The transfer of a plurality of digital products can be done one at a time or in a bulk or batch manner. The product submission and management system 104 can include a product transfer manager 120. The product transfer manager 120 can facilitate transfer of one or more digital products from one content provider to another content provider. Typically, one content provider will have submitted a digital product to the product submission and management system 104 for distribution by the product distribution site 102. However, sometime later that digital product because owned or management by another content provider through a business event (e.g., merger, acquisition, sale, etc.). Advantageously, the product transfer manager 120 can then facilitate the transfer of the digital product from the initial content provider to the new content provider. The transfer of the digital products can not only transfer the digital products but can transfer other data associated with the digital products, such as advertisements, rankings, ratings, feedback, game play information (e.g., leaderboard, play history), feature purchases (e.g., in-app purchases for applications), etc. For example, the product transfer manager 120 can manage the transfer process. The transfer can also transfer appropriate management data. As a result, the transfer requires less effort by content providers and results in more reliable transfer of digital products.

Although the product distribution site 102, the product submission and management system 104 and the products store 106 are shown in FIG. 1 as being separate components, it should be understood that any of these components can be combined into one or more apparatus. For example, the product submission and management system 104 can be incorporated into the product distribution site 102. As another example, the products store 106 can be incorporated into the product distribution site 102 or the product submission and management system 104.

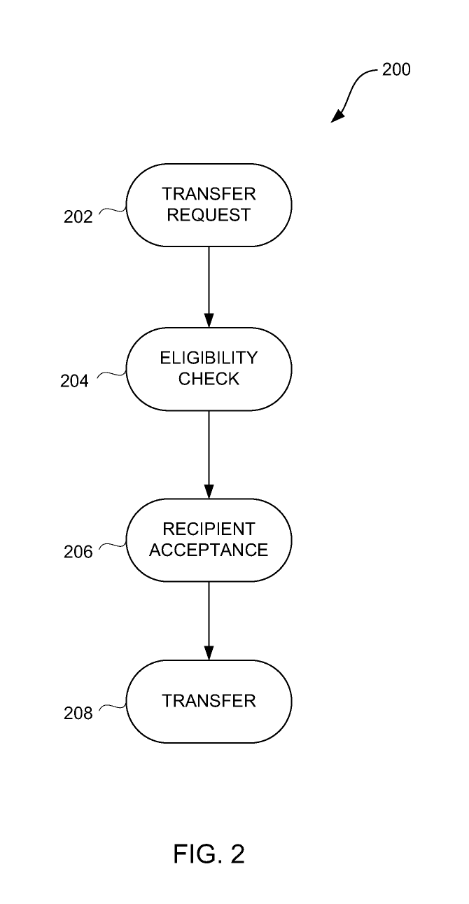

FIG. 2 illustrates a basic state diagram for a transfer process 200 according to one embodiment. The transfer process 200 includes a transfer request state 202 that awaits a transfer request from a requester. The transfer request can specify at least one digital asset and, with the transfer request or subsequently, can also specify a recipient. After a transfer request has been received, the transfer process 200 can transition from the transfer request state 202 to an eligibility check state 204. At the eligibility check state 204, the transfer process 200 can evaluate whether the digital asset is eligible to be transferred and/or whether the recipient is eligible to receive the digital asset to be transferred. If the eligibility check state 204 determines that either the digital asset or the recipient are not eligible to participate in the transfer, then the transfer process can end. Alternatively, if the one or more eligibility checks are satisfied, the transfer process 200 can transition from the eligibility check state 204 to a recipient acceptance state 206. At the recipient acceptance state 206, the recipient is advised of the requested transfer and is then given the opportunity to accept or decline the requested transfer. If the recipient acceptance state 206 determines that the recipient has declined the requested transfer, the transfer process 200 can end. Alternatively, if the recipient acceptance state 206 determines that the recipient has accepted the requested transfer, the transfer process 200 can proceed to a transfer state 208. At the transfer state 208, the requested transfer is implemented by transferring the digital asset from the requester to the recipient. Typically, the requester and the recipient are both account holders of a product submission and management system, such as the product submission and management system 104 illustrated in FIG. 1, and thus the transfer can be electronically performed by the product submission and management system using the account associated with the requester and the recipient.

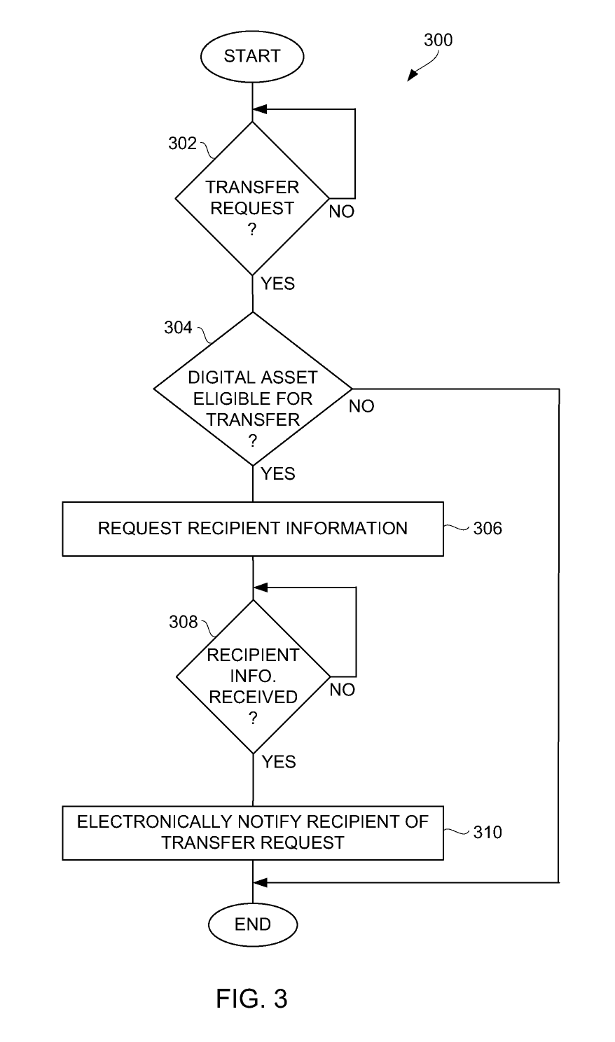

FIG. 3 illustrates a flow diagram of a transfer request process 300 according to one embodiment. The transfer request process 300 can be performed by at least one computing device, such as a computing device associated with the product submission and management system 104 illustrated in FIG. 1.

The transfer request process 300 can begin with a decision 302 that determines whether a transfer request has been received. When the decision 302 determines that a transfer request has not yet been received, the transfer request process 300 can await such a request. The transfer request is a request to transfer a digital asset from a requester to a recipient. Typically, the requester and recipient have accounts (e.g., user accounts) with an online digital asset management system so that the transfer request can operate to electronically transfer the digital asset from one account to another account.

Alternatively, after the decision 302 determines that a transfer request has been received, a decision 304 can determine whether the digital asset being requested for transfer is eligible for transfer. There can any of a number of different reasons why a digital asset is not eligible for transfer. The reasons can be controlled or configured by one or more of content provider, system, or third parties. When the decision 304 determines that the digital asset is eligible for transfer, recipient information can be requested 306 from the requestor. Here, the requestor can specify the recipient that is to receive the digital asset via the transfer. A decision 308 can then determine whether the requested recipient information has been received. When the decision 308 determines that the requested recipient information has not been received, the transfer request process 300 can await the receipt of such information. Alternatively, when the decision 308 determines that the requested recipient information has been received, the recipient can be electronically notified 310 of the transfer request. Following the electronic notification 310, the transfer request process 300 can end. Additionally, following the decision 304, when the digital asset to be transferred is determined not to be eligible for transfer, the transfer request process 300 can also end by bypassing blocks 306-310.

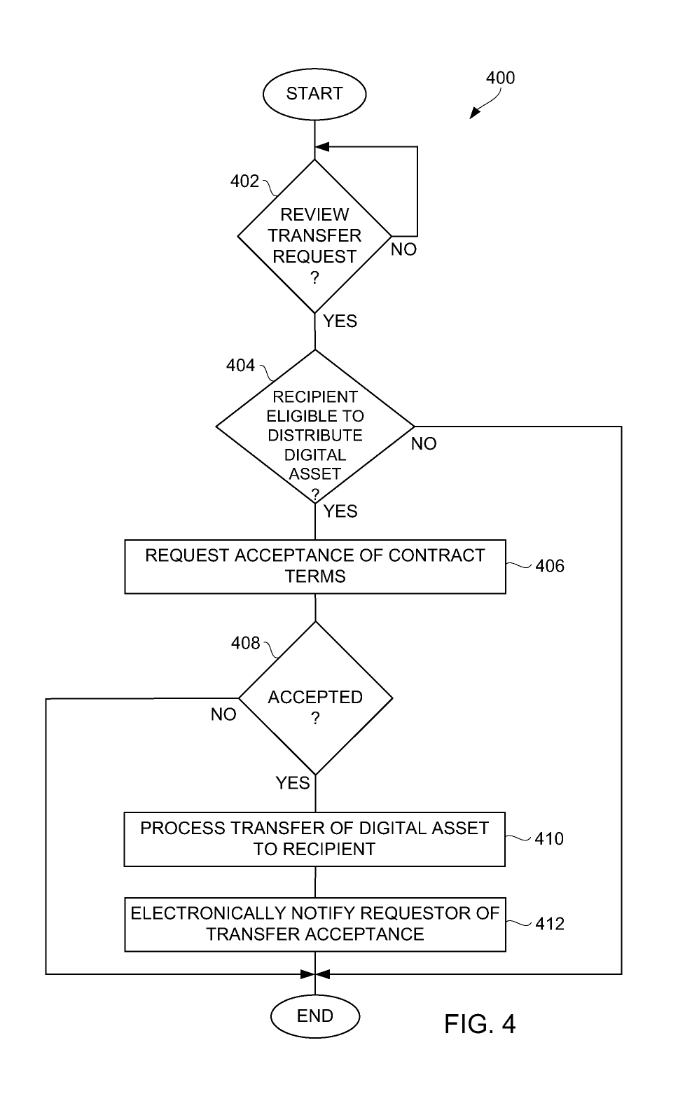

FIG. 4 illustrates a flow diagram of a transfer acceptance process 400 according to one embodiment. The transfer acceptance process can be performed by at least one computing device, such as a computing device associated with the product submission and management system 104 illustrated in FIG. 1.

The transfer acceptance process 400 can begin with a decision 402 that determines whether a transfer request is to be reviewed. A transfer request is a request from the requester to transfer a digital asset to a recipient. When the decision 402 determines that a transfer request is to be reviewed, the transfer acceptance process 400 awaits until a transfer request is to be reviewed.

Once the decision 402 determines that a transfer request is to be reviewed, a decision 404 can determine whether the recipient of the transfer request is eligible to distribute the digital asset associated with the transfer request. Here, a transfer request can be denied if the digital asset to be transferred is not available to be distributed by recipient. For example, the recipient may not be approved (e.g., by the product submission and distribution system 100) to distribute digital assets (e.g., by the production distribution site 102) of any type or at least of the type associated with the digital asset to be transferred. In any case, when the decision 404 determines that the recipient is not eligible to distribute the digital asset to be transferred, the transfer acceptance process 400 can end.

On the other hand, when the decision 404 determines that the recipient is eligible to distribute the digital asset to be transferred, the transfer acceptance process 400 can request 406 acceptance of contract terms by the recipient. The contract terms are terms for a distribution agreement (or distribution contract). Then, a decision 408 of the transfer acceptance process 400 can determine whether the recipient has accepted the contract terms. When the decision 408 determines that the recipient has accepted the contract terms, transfer of the digital asset to the recipient can be processed 410. The processing 410 can operate to reassign the digital asset from the requester to the recipient. For example, the processing 410 can reassign the digital asset by transfer of the digital asset from the requestor's account to the recipient's account. In addition, the requester can be electronically notified 412 of the acceptance of the transfer request by the recipient. Following the notification 412 of the requester, the transfer acceptance process 400 can end. Alternatively, when the decision 408 determines that the contract terms have not been accepted (i.e., rejected), the transfer acceptance process 400 can bypass blocks 410 and 412 and then end.

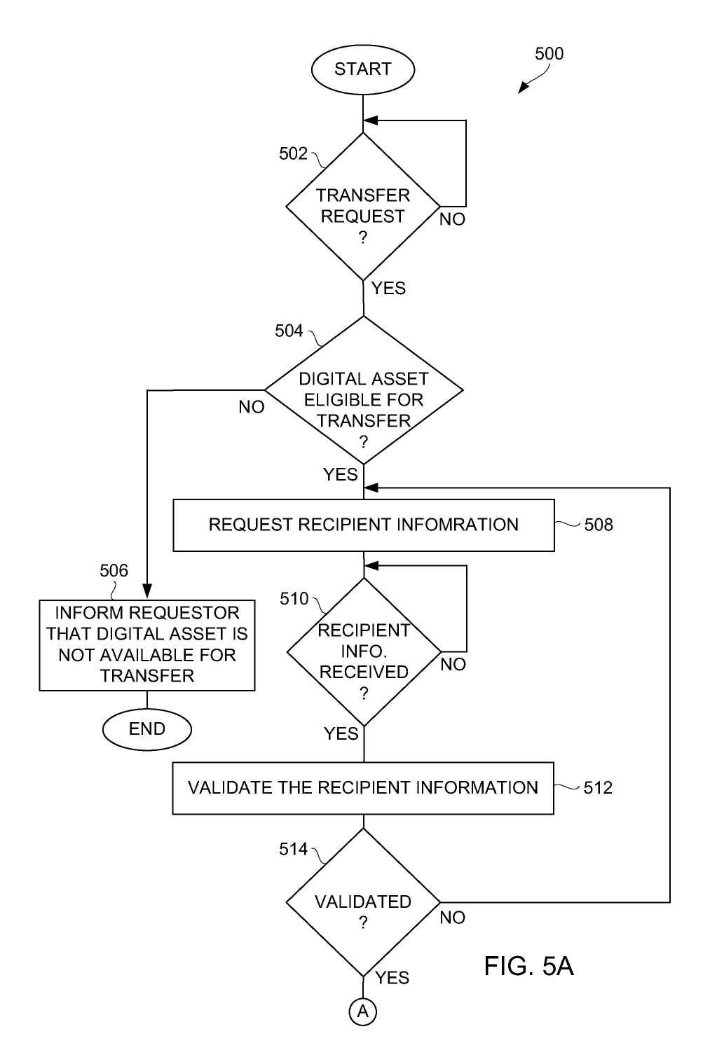

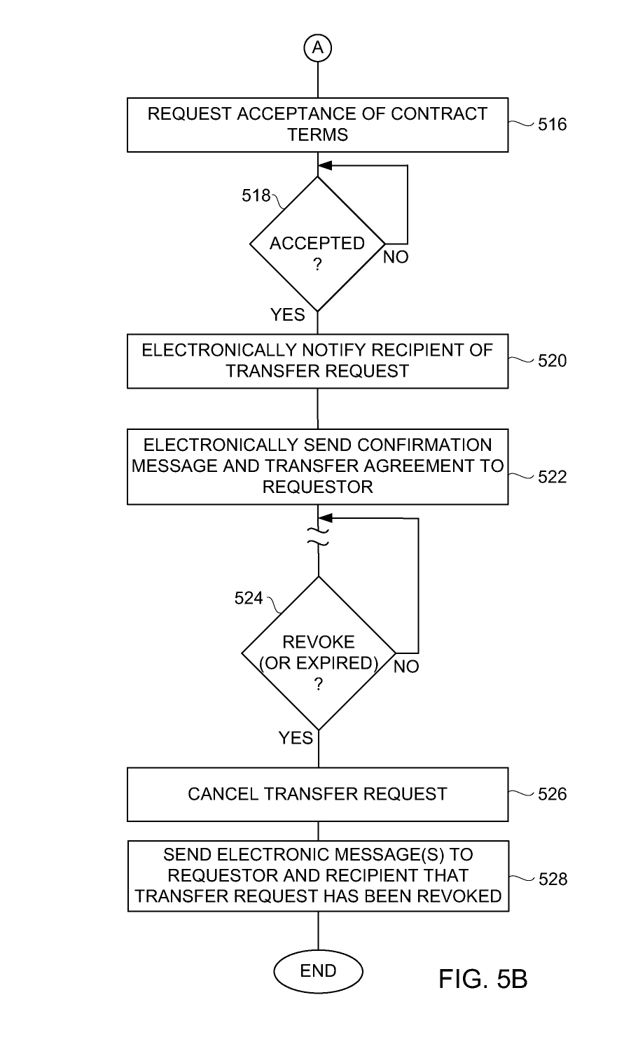

FIGS. 5A and 5B illustrate flow diagrams of a transfer request process 500 according to one embodiment. The transfer request process 500 can be performed by at least one computing device, such as a computing device associated with the product submission and management system 104 illustrated in FIG. 1.

The transfer request process 500 can begin with a decision 502 that determines whether a transfer request has been received. The transfer request is a request to transfer a digital asset from a requester to a recipient. Typically, the requester and recipient have accounts (e.g., user accounts) with an online digital asset management system so that the transfer request can operate to transfer the digital asset from one account to another account. When the decision 502 determines that a transfer request has not been received, the transfer request process 500 can await such a request.

Once the decision 502 determines that a transfer request has been received, a decision 504 can determine whether the digital asset associated with the transfer request is eligible for transfer. For example, the digital asset transfer system may for whatever reason not permit the digital asset to be transferred. Some example of reasons why a digital asset can be ineligible for transfer include: (1) the digital asset is not in a “ready for sale” state, (2) the digital asset is rejected or under review, (3) content provider is rejected or under review, (4) the digital asset is being updated, or (5) appropriate agreements (e.g., distribution agreements) are not up to date. In this case, the requester can be informed 506 that the digital asset is not available for transfer. Following the informing 506 of the requester, the transfer request process 500 can end without transferring the digital asset.

On the other hand, when the decision 504 determines that the digital asset is eligible for transfer, the transfer request process 500 can request 508 recipient information from the requestor. For example, the recipient information can include one or more identifiers (e.g., account identifier) for the recipient. A decision 510 can then determine whether the requested recipient information has been received. When the requested recipient information has not been received, the transfer request process 500 can await the receipt of the recipient information. The recipient information could alternatively be provided with the transfer request.

Once the decision 508 determines that the recipient information has been received, the transfer request process 500 can validate 512 the recipient information. For example, the validation can confirm that the recipient information has been completely provided and that the recipient is a valid account holder (e.g., account holder with the product submission and management system 104). As another example, the validation can also confirm that the recipient is not being updated. As still another example, the validation can confirm that the identifier for the digital asset does not conflict with an identifier already used by the recipient. Once the recipient information is validated 512, a decision 514 can determine whether the recipient information has been successfully validated. When the decision 514 determines that the recipient information has not been successfully validated, the transfer request process 500 can return to repeat the block 508 and subsequent blocks so that the recipient can again try to provide the requested recipient information. Alternatively, although not shown in FIG. 5A, when the decision 514 determines that the recipient information has not been successfully validated, the transfer request process could alternatively end with the transfer request being canceled.

On the other hand, when the decision 514 determines that the recipient information has been successfully validated, acceptance of contract terms to govern the transfer of the digital asset can be requested 516. Here, the requestor is requested to accept the contract terms. The contract terms are terms of a transfer agreement (or transfer contract). A decision 518 can then determine whether the contract terms have been accepted by the requester. When the decision 518 determines that the contract terms have not been accepted by the requester, the transfer request process 500 can await such acceptance. Alternatively, although not shown in FIG. 5A, after an express non-acceptance or after a period of time of no acceptance, the transfer request process 500 can end with the transfer request being canceled.

Alternatively, if the decision 518 determines that the contract terms have been accepted by the requester, the recipient of the transfer request can then be electronically notified 520. The electronic notification of the requester can include the specifics of the transfer request, or can include a hyperlink to the specifics of the transfer request. In addition, a confirmation message along with a copy of the transfer agreement can be electronically sent 522 to the requester. For example, the electronic notification can be implemented as an electronic mail message containing the confirmation message and the copy of the transfer agreement.

Additionally, the transfer request process 500 can include additional processing to facilitate revocation of a previously issued transfer request. For example, in FIG. 5B, the transfer request process 500 can further include a decision 524 that determines whether a previously issued transfer request is to be revoked (or alternatively has expired). When the decision 524 determines that a transfer request has not been revoked (or has not expired), the transfer request process 500 can periodically or when requested perform the decision 524 so as to be advised if the transfer request has been revoked (or has expired). When the decision 524 determines that the transfer request has been revoked (or has expired), the transfer request can be canceled 526. In addition, one or more electronic messages can be sent 528 to the requester as well as the recipient to inform them that the transfer request has been revoked (or has expired). After the one or more electronic messages have been sent 528, the transfer request process 500 can end.

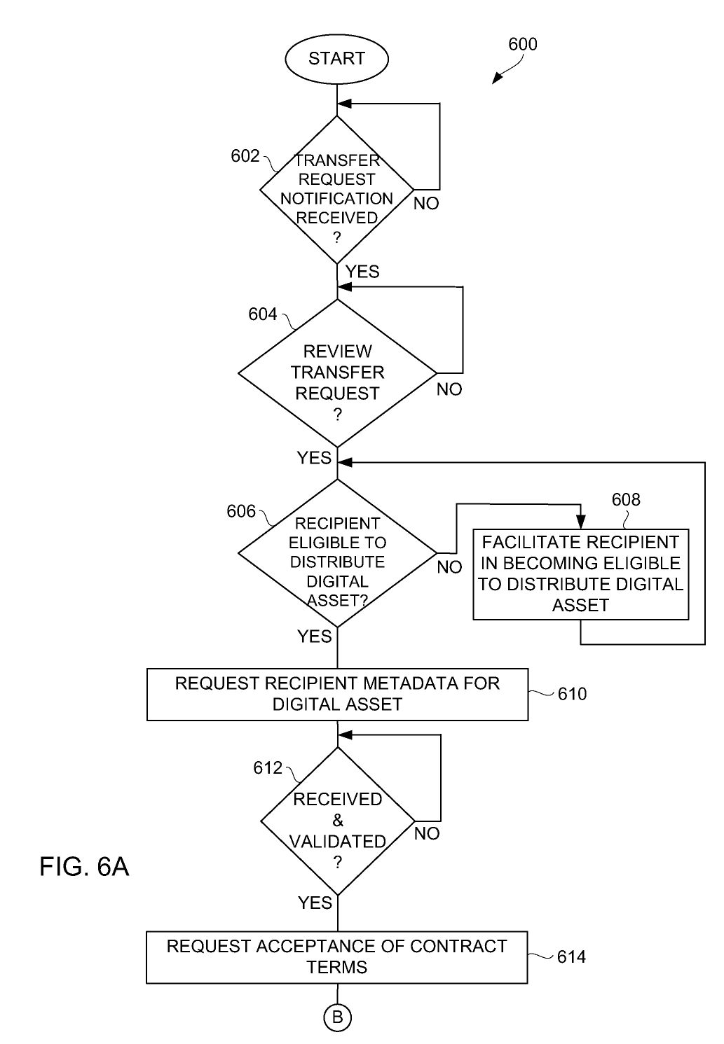

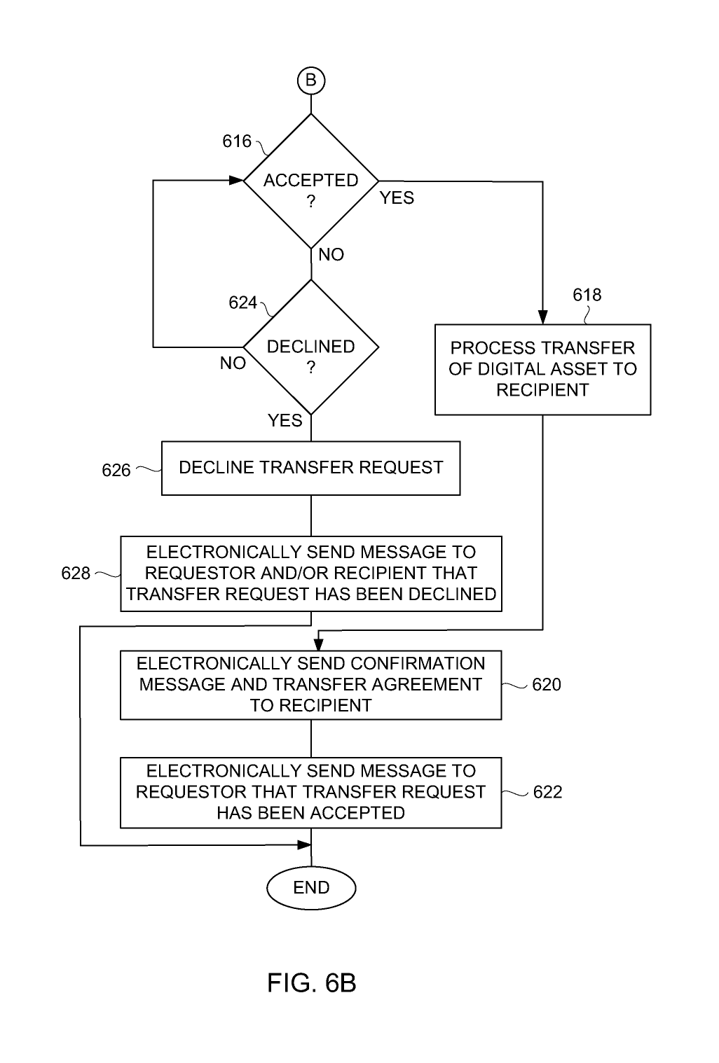

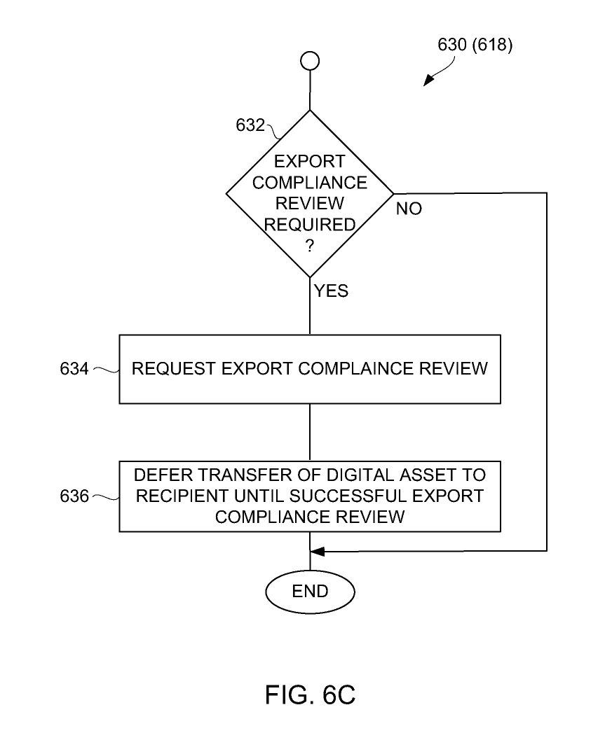

FIGS. 6A and 6B illustrate flow diagrams of a transfer acceptance process 600 according to one embodiment. The transfer acceptance process can be performed by at least one computing device, such as a computing device associated with the product submission and management system 104 illustrated in FIG. 1.

The transfer acceptance process 600 can begin with a decision 602 that determines whether a transfer request notification has been received. When the decision 602 determines that a transfer request notification has not been received, the transfer acceptance process 600 can await receipt of such a notification. Once the decision 602 determines that a transfer request notification has been received, the transfer acceptance process 600 can continue. In this regard, a decision 604 can determine whether the transfer request is to be reviewed. When the decision 604 determines that the transfer request is not to be reviewed at this time, the transfer acceptance process 600 can await the appropriate time to review the transfer request. As an example, the recipient of the transfer request notification can control when the transfer request is to be reviewed. For example, the recipient could access the product transfer manager 120 and/or their account with the product submission and management system 104 illustrated in FIG. 1 to access transfer request information.

After the decision 604 determines that the transfer request is to be reviewed, a decision 606 can determine whether the recipient is eligible to distribute the digital asset associated with the transfer request. When the decision 606 determines that the recipient is not eligible to distribute the digital asset, the transfer acceptance process 600 can facilitate 608 the recipient in becoming eligible to distribute the digital asset. Following the block 608, the transfer acceptance process 600 can return to repeat the decision 606.

Once the decision 606 determines that the recipient is eligible to distribute the digital asset, recipient metadata for the digital asset can be requested 610. Here, the recipient metadata for the digital asset is requested 610 from the recipient. The recipient metadata can include new metadata for the digital asset or changes to previously existing metadata for the digital asset. For the recipient metadata can include one or more of: (1) a support email address, (2) a support URL, (3) a marketing URL, (4) a privacy policy URL, or (5) export compliance documents. The recipient metadata can be requested 610 using a graphical user interface that display one or more dialog boxes requesting such information. Some digital assets make require export compliance and others may not. Hence, in one embodiment, if the requestor had previously provided export compliance documentation, then the recipient metadata being requested 610 can thus request export compliance documentation from the recipient. Alternatively, if the requestor had previously not provided export compliance documentation, then the recipient metadata being requested 610 need not request export compliance documentation from the recipient.

After the recipient metadata has been requested 610, a decision 612 can determine whether the recipient metadata is received and validated. When the decision 612 determines that the recipient metadata has not been received and validated, the transfer acceptance process 600 can await the receipt and validation of the requested recipient metadata.

Alternatively, after the decision 612 determines that the recipient metadata has been received and validated, acceptance of contract terms by the recipient can be requested 614. The contract terms are terms of a transfer agreement (or transfer contract). Next, a decision 616 can determine whether the contract terms have been accepted by the recipient. Typically, the contract terms being accepted by the recipient are the same contract terms agreed to by the requestor (e.g., block 518 of FIG. 5A).

When the decision 616 determines that the contract terms have been accepted, the transfer acceptance process 600 can process 618 transfer of the digital asset to the recipient. For example, the transfer of the digital asset to the recipient can involve moving the associated digital asset and its usage rights from the user account associated with the requestor to the user account associated with the recipient. The transfer of the digital asset to the recipient can also include transfer of associated data, such as data associated with advertisements, game play (e.g., leaderboard, play history), rankings, ratings, feature purchases, content provider resources (e.g., developer resources), etc. For example, if the digital asset is an application program, then the feature purchases being transferred can include any feature purchases (e.g., in-app purchases) that have been previously made with respect to the application program. Following the transfer of the digital asset, the recipient is able to manage the digital asset at the online digital asset distribution system. After the transfer of the digital asset to the recipient has been processed 618, a confirmation message and a copy of the transfer agreement can be electronically sent 620 to the recipient. In addition, a message can be electronically sent 622 to the requester to inform the requester that the transfer request has been accepted. Following the block 622, the transfer acceptance process 600 can end.

On the other hand, when the decision 616 determines that the acceptance of the contract terms has not yet been made, a decision 624 can determine whether the transfer request has been declined by the recipient. When the decision 624 determines that the transfer request has not been declined, the transfer acceptance process 600 can return to repeat the decision 616 to await either acceptance or decline of the contract terms for the transfer request. When the decision 624 determines that the transfer request has been declined, the transfer acceptance process 600 can decline 626 the transfer request. Here, the transfer request is deactivated such that it can no longer be performed. In addition, a message can be electronically sent 628 to the requester and/or the recipient to inform them that the transfer request has been declined. Following the block 628, the transfer acceptance process 600 can end.

In addition, the transfer acceptance process 600 could also process the expiration of the transfer request in a manner similar to that of the declined of the transfer request. As such, if the transfer request expires (such as after a predetermined amount of time), the transfer request can be deemed to have been declined. In such case, the transfer request is no longer active and the requester and the recipient can be notified that the transfer request has expired.

FIG. 6C illustrates a flow diagram of processing associated with export processing 630 of the digital asset to a recipient. The export processing 630 can, for example, be processing associated with the block 618 illustrated in FIG. 6B. In any event, the export processing 630 can begin with a decision 632 that determines whether an export compliance review is required. When the decision 632 determines that an export compliance review is required, an export compliance review can be requested 634. Then, the transfer of the digital asset to the recipient can be deferred 636 until successful export compliance review. Alternatively, when the decision 632 determines that export compliance review is not required, the blocks 634 and 636 can be bypassed.

Additionally, in some embodiments, the extent of the transfer can be controlled. For example, the system, a requestor and/or a recipient could limit the transfer of a quantity of digital assets or limit the types of associated data that are transferred with the associated digital asset. As one example, a transfer could transfer a digital asset with it associated ranking and rating data but not transfer its feature purchases. As another example, a transfer could restrict the quantity of a set of digital assets to be transferred, such as transferring only a subset of episodes of a digital asset series of episodes.

The transfer of the digital asset to the recipient can also include transfer of associated data, such as data associated with advertisements, game play (e.g., leaderboard, play history), rankings, ratings, feature purchases, content provider resources (e.g., developer resources), etc. For example, if the digital asset is an application program, then the feature purchases being transferred can include any feature purchases (e.g., in-app purchases) that have been previously made with respect to the application program.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for transferring a digital asset from one user account of an online asset distribution system to another user account, the method comprising:
receiving a transfer request from a requestor, the transfer request being associated with at least one particular digital asset currently associated with the requestor at the online asset distribution system;
determining whether the at least one particular digital asset is eligible for transfer;
informing the requestor that the at least one particular digital asset is not eligible for transfer, if the determining determines that the at least one particular digital asset is not eligible for transfer;
receiving information pertaining to a recipient that is to receive the at least one particular digital asset if the determining determines that the at least one particular digital asset is eligible for transfer;
validating, after receiving the information pertaining to the recipient, that the recipient is a permitted recipient of the at least one particular digital asset;
subsequently receiving a transfer contract acceptance from the recipient indicating acceptance of a transfer contract governing the transfer of the digital asset from the requestor to the recipient; and
initiating, after receiving the transfer contract acceptance, transfer of the digital asset from the requestor to the recipient.

2. A computer-implemented method as recited in claim 1, wherein the method comprises:
electronically notifying the recipient that a transfer request to them has been made.

3. A computer-implemented method as recited in claim 1, wherein the method comprises:
receiving asset metadata changes from the recipient.

4. A computer-implemented method as recited in claim 1, wherein the method comprises:
receiving at least one export compliance document from the recipient.

5. A computer-implemented method as recited in claim 1, wherein the method comprises:
receiving at least one privacy policy document from the recipient.

6. A computer-implemented method as recited in claim 1, wherein the method comprises:
electronically sending a confirmation of the transfer request and an electronic copy of the transfer request to the requestor.

7. A computer-implemented method as recited in claim 1, wherein the digital asset being transferred is a computer software program.

8. A computer-implemented method as recited in claim 1, wherein the method comprises:
receiving from the recipient a denial of the transfer request; and
denying the transfer request if a denial of the transfer request is received.

9. A computer-implemented method as recited in claim 1, wherein the method comprises:
receiving from the requestor a cancellation of the transfer request; and
canceling the transfer request if a cancellation of the transfer request is received.

9. A computer-implemented method as recited in claim 1, wherein the method comprises:
determining whether the recipient is eligible to distribute the at least one particular digital asset; and
preventing transfer of the at least one particular digital asset to the recipient if the recipient is eligible to distribute the at least one particular digital asset.

10. A computer-implemented method as recited in claim 9, wherein the determining whether the recipient is eligible to distribute the at least one particular digital asset is based on whether the recipient has a distribution contract with the online asset distribution system for distribution of digital assets of a type of the at least one particular digital asset.

11. A non-transitory computer readable medium including at least computer program code tangibly stored thereon for transferring a digital asset from a requestor to a recipient, the digital asset being available for distribution from an online asset distribution system, the computer readable medium comprises:
computer program code for receiving a transfer request from the requestor, the transfer request being associated with the transfer of at least one particular digital asset currently associated with the requestor to the recipient;
computer program code for determining whether the at least one particular digital asset is eligible for transfer;
computer program code for receiving information pertaining to a recipient that is to receive the at least one particular digital asset if the determining determines that the at least one particular digital asset is eligible for transfer; and
computer program code for electronically notifying the recipient that a transfer request to them has been made.

12. A non-transitory computer readable medium as recited in claim 11, wherein the digital asset being transferred is a computer software program.

13. A non-transitory computer readable medium as recited in claim 11, wherein the computer readable medium comprises:
computer program code for receiving a transfer contract acceptance from the recipient for indicating acceptance of a transfer contract governing the transfer of the digital asset from the requestor to the recipient; and
computer program code for initiating transfer of the digital asset from the requestor to the recipient after receiving the transfer contract acceptance from the recipient.

14. A non-transitory computer readable medium as recited in claim 11, wherein the computer readable medium comprises:
computer program code for electronically sending a confirmation of the transfer request and an electronic copy of the transfer request to the requestor.

15. A non-transitory computer readable medium as recited in claim 13, wherein the computer readable medium comprises:
computer program code for electronically notifying the requestor and/or the recipient that the transfer of the at least one particular digital asset from the requestor to the recipient has been performed.

16. A non-transitory computer readable medium as recited in claim 13, wherein the computer readable medium comprises:
computer program code for transferring the digital asset and associated data from the account associated with the requestor to the account associated with the recipient.

17. A non-transitory computer readable medium as recited in claim 11, wherein the computer readable medium comprises:
computer program code for validating the received information pertaining to the recipient; and
computer program code for determining whether the recipient is a permitted recipient of the at least one particular digital asset based on whether the received information pertaining to the recipient has been validated by the computer program code for validating.

18. A non-transitory computer readable medium as recited in claim 11, wherein the computer readable medium comprises:
computer program code for causing the requestor to be notified that the at least one particular digital asset is not eligible for transfer, if the computer program code for determining determines that the at least one particular digital asset is not eligible for transfer.

19. A non-transitory computer readable medium as recited in claim 11, wherein the computer readable medium comprises:
computer program code for receiving asset metadata changes from the recipient.

20. A non-transitory computer readable medium as recited in claim 11, wherein the computer readable medium comprises:
computer program code for receiving at least one export compliance document from the recipient.

21. A non-transitory computer readable medium as recited in claim 11, wherein the computer readable medium comprises:
computer program code for receiving at least one privacy policy document from the recipient.

22. A non-transitory computer readable medium as recited in claim 11, wherein the computer readable medium comprises:
computer program code for electronically sending a confirmation of the transfer request and an electronic copy of the transfer request to the requestor.

23. A computing system for supporting an online asset distribution system, comprising:
at least one memory configured to store user account information and computer program code; and
a least one computing device for executing at least a portion of the computer program code for transferring a digital asset from a requesting user to a recipient user, both the requesting user and the recipient user having accounts with the online asset distribution system,
wherein the computer readable medium includes at least:
computer program code for receiving a transfer request from the requestor, the transfer request being associated with the transfer of at least one particular digital asset currently associated with the requestor to the recipient;
computer program code for determining whether the at least one particular digital asset is eligible for transfer;
computer program code for receiving information pertaining to a recipient that is to receive the at least one particular digital asset if the determining determines that the at least one particular digital asset is eligible for transfer; and
computer program code for electronically notifying the recipient that a transfer request to them has been made.
